(19) United States
(12) Patent Application Publication
(10) Pub. No.: US 2012/0109759 A1
(43) Pub. Date: May 3, 2012

(54) SPEECH RECOGNITION SYSTEM PLATFORM

(76) Inventors: Yaron Oren, San Francisco, CA (US); Heath Ahrens, Boonton, NJ (US)

(21) Appl. No.: 13/283,236

(22) Filed: Oct. 27, 2011

Related U.S. Application Data
(60) Provisional application No. 61/455,845, filed on Oct. 27, 2010.

(51) Int. Cl. G06Q 30/02; G10L 13/08

(52) U.S. Cl. 705/14.72; 704/260; 704/E13.001

(57) ABSTRACT

A device including a processor and a memory, the processor operating software performing a method of providing content to a device, the method including the steps of receiving an input from a sending device, gathering information pertaining to the sending device or a receiving device, searching a storage unit for content related to the information and the input, generating a message based on the content returned from the storage unit, incorporating the message into the input, transmitting the input including the message to the receiving device.

### CROSS-REFERENCE TO RELATED APPLICATIONS

The present application claims the benefit of U.S. Provisional Patent Application No. 61/455,845 titled “TEXT TO SPEECH ADVERTISEMENT DELIVERY SYSTEM & APPARATUS,” filed Oct. 27, 2010, the entire contents of which are incorporated herein by reference.

### FIELD OF THE INVENTION

The present invention is generally related to text to speech communications and more particularly to advertisement placement and delivery within text to speech communications.

### BACKGROUND OF THE INVENTION

Countless opportunities exist for advertisers to reach their key targets with respect to text to speech communications. Currently, numerous messages are converted from text to speech on a daily basis. The messages conveyed in this medium contain invaluable information about individuals using this medium to communicate with one another. Advertisers seeking certain customers or target audiences may be able to use such information in the targeted campaigns. To date, there are no effective advertising opportunities in text to speech (TTS) communications. In addition, there is a lack of interactive advertisement opportunities in TTS inputs that notifies a user of opportunities and enables connection with the vendors, people, entities, etc. of interest. There is also a need for a fully voice activated system in TTS inputs to effect many mobile phone functions.

### SUMMARY OF THE INVENTION

Various embodiments of the present disclosure provide a device including a processor and a memory, the processor operating software performing a method of providing content to a device, the method including the steps of receiving an input from a sending device, gathering information pertaining to the sending device or a receiving device, searching a storage unit for content related to the information and the input, and generating a message based on the content returned from the storage unit.

Another embodiment provides an advertisement system having a content creation device including an input receiving unit that receives an input from a sending device, an information gathering unit that gathers information pertaining to the sending device or a receiving device, a content storage unit, a message generation unit that searches the content storage unit for content based on the sending or receiving device and the input, where the message generation unit incorporates the message into the input, a content presentation unit that transmits the input including the message to the receiving device.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements.

FIG. 1 depicts a block diagram of a speech and text communication system suitable for use with the methods and systems consistent with the present invention;

FIGS. 2A and 2B depict a detailed depiction of computers utilized in the speech and text communication system of FIG. 1;

FIG. 3 depicts a schematic representation of the operation of the speech to text communication system of FIG. 1;

FIG. 4 depicts a schematic representation of the operation of the content presentation unit of FIG. 1;

FIG. 5 is illustrative of the operation of the speech to text communication system of FIG. 1;

FIG. 6 is illustrative of the operation of the speech to text communication system of FIG. 1; and

FIG. 7 is illustrative of the operation of the speech to text communication system of FIG. 1.

### DETAILED DESCRIPTION OF THE DRAWINGS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention,” relates to a requirement of the United States Patent Office, and does not imply, nor should be inferred to limit the subject matter disclosed herein.

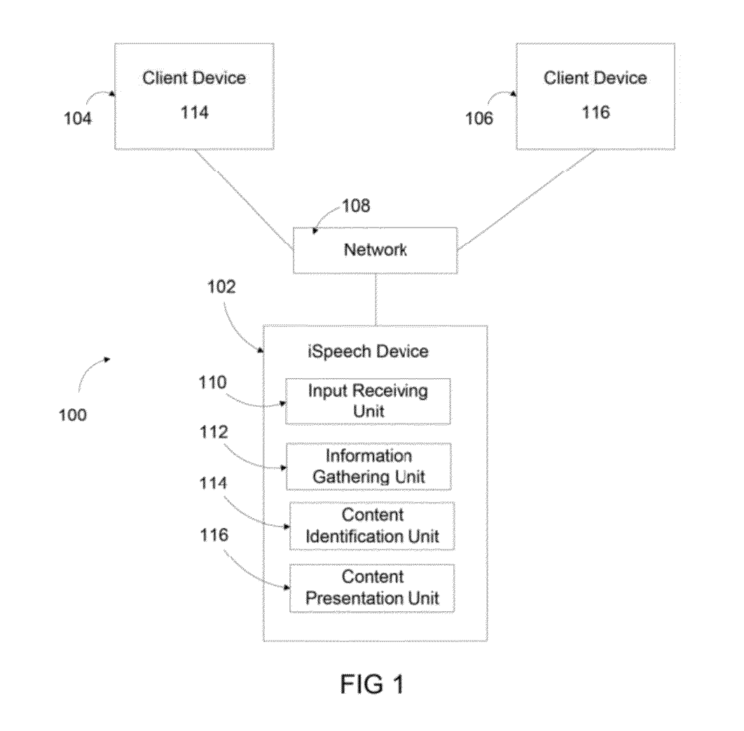

FIG. 1 depicts a block diagram of a speech and text communication system 100 suitable for use with the methods and systems consistent with the present invention. The speech and text communication system 100 comprises a plurality of computers 102, 104 and 106 connected via a network 108. The network is of a type that is suitable for connecting the computers for communication, such as a circuit-switched network or a packet-switched network. Also, the network may include a number of different networks, such as a local area network, a wide area network such as the Internet, telephone networks including telephone networks with dedicated communication links, connection-less network, and wireless networks. In the illustrative example shown in FIG. 1, the network is the Internet. Each of the computers shown in FIG. 1 is connected to the network via a suitable communication link, such as a dedicated communication line or a wireless communication link.

In an illustrative example, computer 102 serves as a speech and text communication management unit that includes an input receiving unit 110, an information gathering unit 112, a content identification unit 114, and a content presentation unit 116. The number of computers and the network configuration shown in FIG. 1 are merely an illustrative example. One having skill in the art will appreciate that the system may include a different number of computers and networks. For example, computer 102 may include the input receiving unit 110, as well as, the information gathering unit 112. Further, the content identification unit 114 and content presentation unit 116 may reside on a different computer than computer 102.

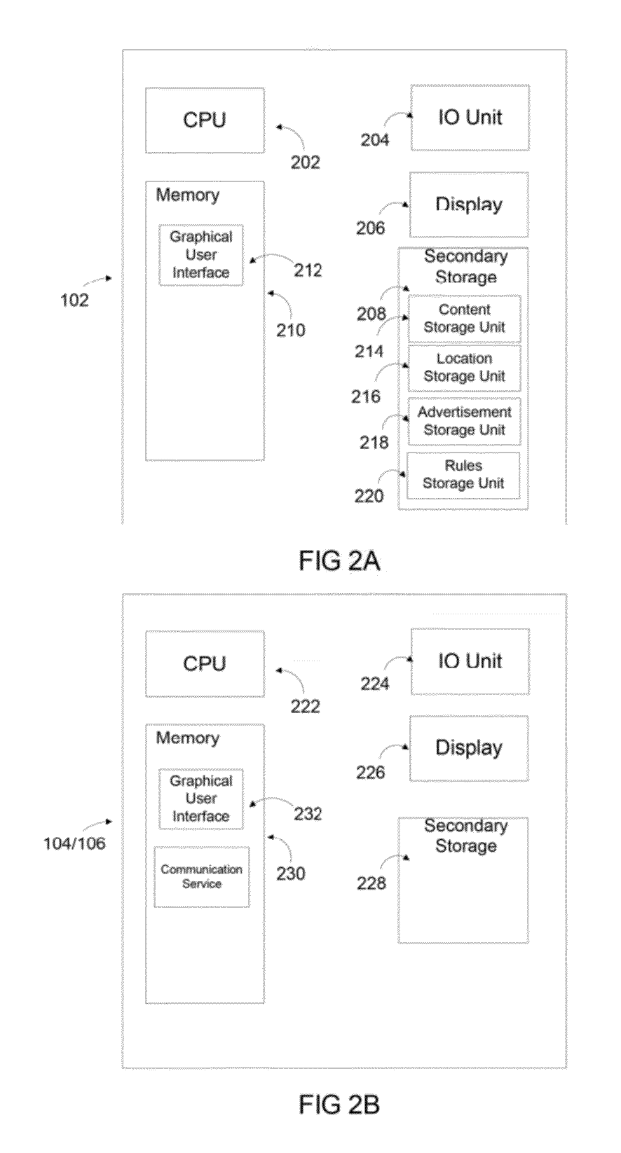

FIG. 2A shows a more detailed depiction of computer 102. Computer 102 comprises a central processing unit (CPU) 202, an input output (I/O) unit 204, a display device 206, a secondary storage device 208, and a memory 210. Computer 102 may further comprise standard input devices such as a keyboard, a mouse, a digitizer, or a speech processing means (each not illustrated).

Computer 102's memory 210 includes a Graphical User Interface (“GUI”) 212, which is used to gather information from a user via the display device 206 and I/O unit 204, as described herein. The GUI 212 includes any user interface capable of being displayed on a display device 206 including, but not limited to, a web page, a display panel in an executable program, or any other interface capable of being displayed on a computer screen. The secondary storage device 208 includes a content storage unit 214, a location storage unit 216, an advertisement storage unit 218, and a rules storage unit 220. Further, the GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer®, Google Chrome® or any other commercially available HTML viewing software.

FIG. 2B shows a more detailed depiction of user computers 104 and 106. User computers 104 and 106 each comprise a central processing unit (CPU) 222, an input output (I/O) unit 224, a display device 226, a secondary storage device 228, and a memory 230. User computers 104 and 106 may each comprise standard input devices such as a keyboard, a mouse, a digitizer or a speech processing means (each not illustrated).

User computers 104 and 106 memory 230 includes a GUI 232, which is used to gather information from a user via the display device 226 and 110 unit 224, and a communication service 214 used to present communications to the user operating the user computer 104 or 106, as described herein. The GUI 232 includes any user interface capable of being displayed on a display device 226 including, but not limited to, a web page, a display panel in an executable program, or any other interface capable of being displayed on a computer screen. The GUI 232 may also be stored in the secondary storage unit 228. The GUI 232 may also be displayed using commercially available HTML, as previously discussed.

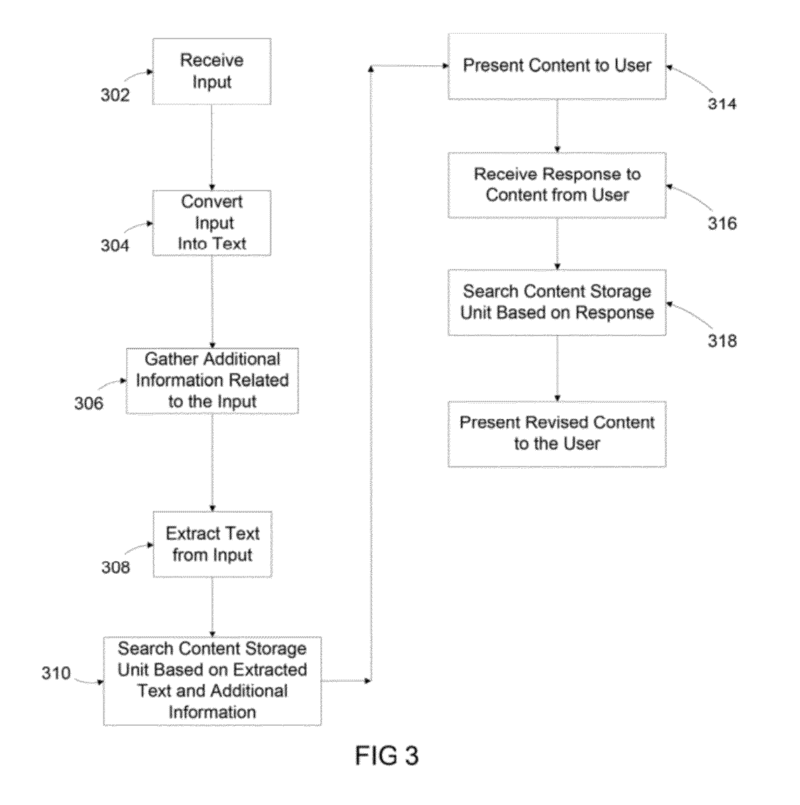

FIG. 3 is a schematic representation of the operation of a speech and text communications system 100. First, at step 302, an input receiving unit 110 operating in the processor of the computer 102 receives an input. The input may include, but is not limited to an audio signal, a text input, or an image input. The input may be transmitted to the input receiving unit 110 as a digital communication such as, but not limited to, a short messaging service message “SMS,” an electronic mail message, a RSS feed, a text file, an audio stream, a video stream, an image file, or any other format containing digital information. The input may also be captured by a device coupled to the 110 unit of the computer 102 connected to the system.

In step 304, the input is converted into a text format. The process of converting different formats into text is known in the art. Audio signals, for example, may be converted to text using commercially available speech to text software including, but not limited to, Dragon Naturally Speaking® Software, Microsoft Speech to Text®, Sphnix®, or any other available software capable of converting an audio signal into a text based document.

If the input is determined to be a video or image format, the system analyzes the video, or image input, to identify objects and text in the image or video, and stores text descriptions of the identified objects in the memory 210 of the computer 102. Objects are identified using any commercially available object identification software including, but not limited to, object recognition software from Kooba®, LTU Technologies, or any other software capable of identifying objects in a digital image. As an illustrative example, the object recognition unit may identify a landmark, such as the Willis Tower, in an image. Upon identifying the Willis Tower, the object recognition unit stores the words Chicago, skyscraper, vacation, tourist, etc. as text in the memory 210 of the computer 102.

In step 306, the information gathering unit 112 identifies additional content associated with the input, the user computer 104, 106 receiving the input, or the user computer 104, 106 sending the input. The information gathering unit 112 may receive information on the location of the user computer 104, 106 sending or receiving the input, using a Global Positioning System (“GPS”) unit connected to the I/O unit 202 of the user computer 104, 106. The GPS provides location information of the user computer 104, 106 receiving the input, or sending the input, and stores this location information in the memory 210 of the computer 102.

In step 308, a content identification unit 114 operating in the CPU 202 extracts text from the input stored in the memory 210, and searches a content storage unit 214 based on the extracted text, and the additional content associated with the input, to generate a list of keywords. In step 310, the content identification unit 114 queries the content storage unit 214 for content associated with the keywords and the location information.

The content identification unit 114 may rank each identified keyword based on a plurality of criteria including, but not limited to, the number of occurrences of a word in the text, a topic associated with each extracted word, or any other criteria which would indicate the importance of one extracted word over another extracted word. The content identification unit 114 may extract a plurality of words similar to the extracted word from the content storage unit 214. The content identification unit 114 may also extract a plurality of categories from the content storage unit 214 by querying the content storage unit 214 for words associated with the extracted words. The content identification unit 114 may initially query the content storage unit 214 for content associated with the highest ranking extracted word.

In step 312, a content presentation unit 116 presents the content returned from the content storage unit 214 to a user of the computer 104, 106. In step 314, the content presentation unit 116 receives a response back from the user. In step 316, the content presentation unit 116 searches the content storage unit 214 for additional content based on the user's response. In step 318, the content presentation unit 116 generates a second content based on the user response, and presents the second content to the user.

In step 316, the content presentation unit 116 may present the next content extracted from the content storage unit 214 to the user computer 104, 106. The content presentation unit 116 may also query the user for additional information that is used to modify the query of the content storage unit 214. The content presentation unit 116 may also transmit the information to the content identification unit 114, which then queries the content storage unit 214 based on the user's response to the content.

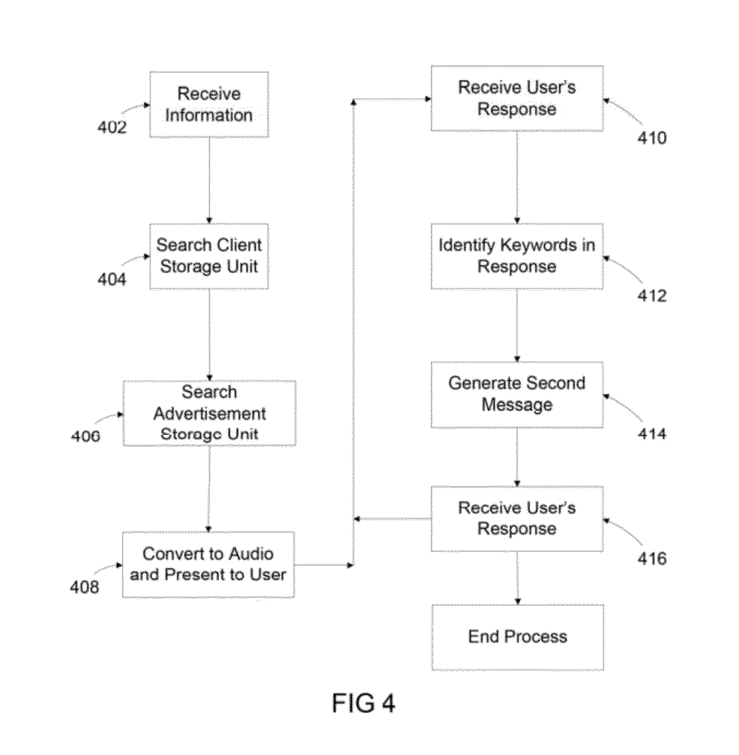

FIG. 4 is a schematic representation of one embodiment of the operation of the content presentation unit 116. In step 402, the content presentation unit 116 receives the keywords extracted from the content storage unit 214. In step 404, the content presentation unit 116 searches a location storage unit 216, in the secondary storage 208 of the computer 100, for the clients associated with the keywords received from the content identification unit 114, and the additional information from the information gathering unit 112. As an illustrative example, the content presentation unit 116 may receive the keyword “coffee” from the content identification unit 114 and the GPS coordinates of the user receiving the input from the user computer 104, 106. The content presentation unit 116 then searches the location storage unit 216 for a client associated with the word “coffee” that is located within a predetermined distance of the user receiving the input, and returns the results to the content presentation unit 116.

In step 406, the content presentation unit 116 searches an advertisement storage unit 218 for advertisements associated with the identified client. In step 408, a grammatical unit, operating in the content presentation unit 116, analyzes the text from the returned advertisement storage unit 218, and the input received from the input receiving unit 112, to generate an introductory question to present to the user that is incorporated into the original input. In one embodiment, the grammatical unit categorizes the grammatical structure of the information received from the content identification unit 114, and the original input, and arranges the information into a question that is incorporated into the original input.

In step 410, a text to speech conversion unit, operating in the content presentation unit 116, converts the question generated by the grammatical unit into an audio signal, and presents the audio signal to the user receiving the input via a speaker coupled to the user's computer 104, 106. The audio signal may be presented along with the input that was originally received by the input receiving unit 110. The audio signal may also be presented separately from the input that was originally received by the input receiving unit 110. As an illustrative example, the input receiving unit 110 may have originally received a message that says “I am really tired. I need coffee!” After this message is processed as previously discussed, the content presentation unit 116 may insert the generated question at the end of the message before it is sent to the user which states “I am really tired. I need coffee! Would you like coffee?”

In step 412, the content presentation unit 116 receives a response to the first question from the user. In one embodiment, monitoring software operating in the processor of the user computer 104, 106 captures and digitizes audio from a microphone connected to the user computer 104, 106. In another embodiment, the content presentation unit 116 receives an input directly from the user computer 104, 106, which includes the response to the question presented by the content presentation unit 116. As an illustrative example, the user may response to the question, “Would you like coffee?” by saying “Yes” into a microphone coupled to the user computer 104, 106. The content presentation unit 116 converts the audio of the response into text and identifies each keyword in the response.

In step 414, the content presentation unit 116 identifies keywords in the response, which are inputted into a decision matrix. The content presentation unit 116 analyzes each of the received keywords based on keywords in the decision matrix. When a keyword is identified in the decision matrix, the decision matrix returns a specific action, which the content presentation unit 116 takes in response to the identified keyword. The decision matrix may direct the content presentation unit 116 to gather additional information on the identified client. The decision matrix may also direct the content presentation unit 116 to gather information pertaining to the client in relation to the user's location. The decision matrix may also direct the content presentation unit 116 to retrieve an advertisement associated with the client from the advertisement storage unit 218. The decision matrix may also direct the content presentation unit 116 to perform multiple activities, such as gathering step by step driving directions to guide the user from the user location to the client location. The content presentation unit 116 may also interact with a web page, to post, or adjust information displayed on a web page.

In step 416, the content presentation unit 116 generates the second message using the additional information gathered as a result of the decision matrix. The grammatical unit identifies the sentence structure of the additional information, and inserts bridge words into the sentence structure based on a plurality of grammatical rules, and bridge words, stored in the rule storage unit 220. The rules in the rule storage unit 220 include rules on sentence structure and word arrangement. The grammatical unit parses the text of the advertisement and identifies each word in the text using conventional word identification software, such as Microsoft® Speech to Text, Java® Speech API, or any other word recognition software. The grammatical unit then arranges the words using the grammatical rules extracted from the rule storage unit 220 for the selected sentence structure. The newly formulated text file is then converted to an audio file using a conventional text to speech generator. In step 416, the content presentation unit 116 receives a second response to the second message and re-initiates the process beginning at step 412.

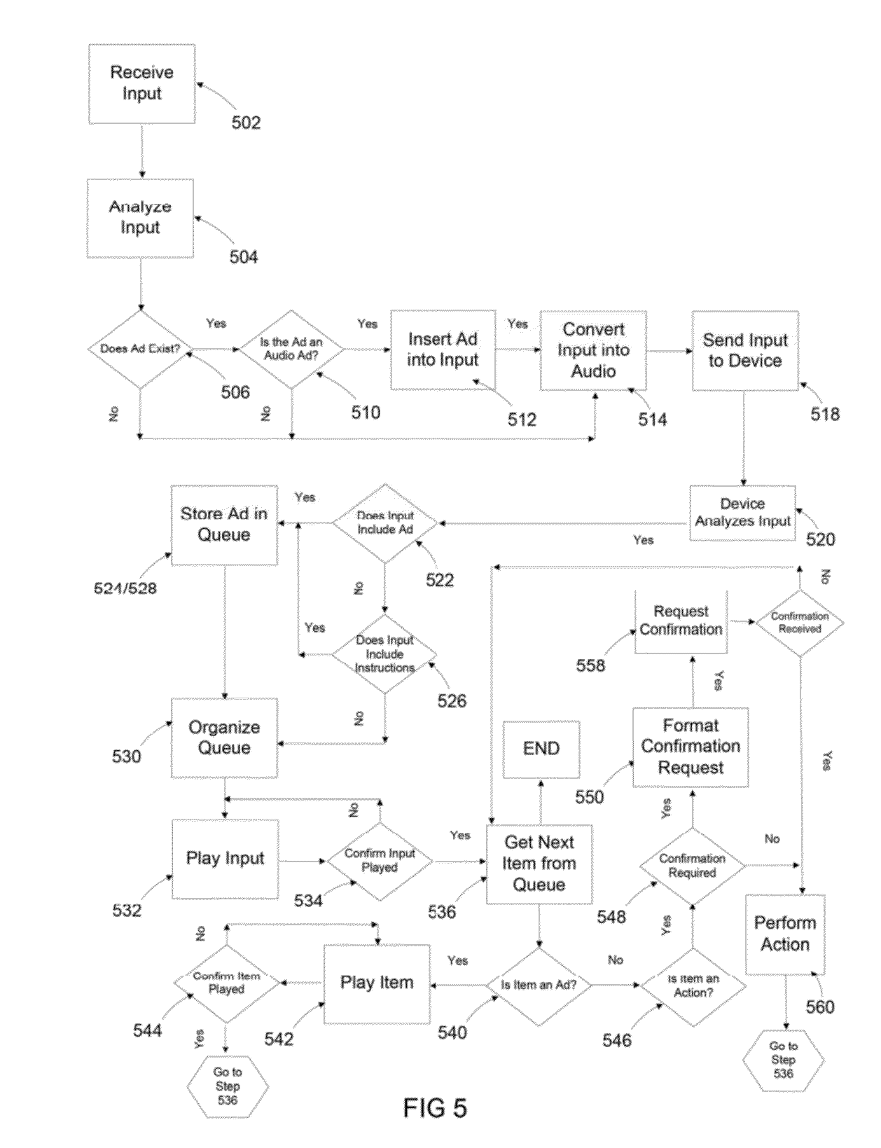

FIG. 5 is illustrative of the operation of the speech to text communication system 100. The process begins with the transmission of text to speech (TTS) input in step 502 from the communication service 234. Such communications could be user generated diction, text messages, the user's utterance, a newsfeed, textual content of URLs, or any form of communication bearing textual content. In step 504, the content presentation unit 116 analyzes the TTS input.

The process then proceeds to step 506 where the content presentation unit 116 determines whether an advertisement based on the key word or words exist(s) in the advertisement storage unit 218. If a specific advertisement exists, the applicable advertisement is retrieved. For instance, if the user obtained an SMS message from a friend where the friend said, “I am hungry,” the content presentation unit 116 may select and identify the word “hungry” and then correlate the word with advertisements in the advertisement storage unit 218 concerning eateries. The content presentation unit 116 may analyze information or data with respect to the user, the communication service 234 being used, the user's demographic data, age, location etc., in searching the advertisement storage unit 218 for applicable advertisements. If an advertisement exists in the advertisement storage unit 218, the content presentation unit 116 determines, in step 510, whether the advertisement is an audio advertisement. If the advertisement is an audio advertisement, the content presentation unit 116, in step 512, injects the text of the advertisement into the TTS content or communication before converting the TTS input into audio, in step 514. If an advertisement does not exist, the process moves on to step 514 where the TTS input is converted into audio.

Once the TTS input has been converted into audio in step 514, the advertisement storage unit 218 then packages the converted TTS input, the audio advertisement (if one exists as determined in step 510), and instructions for the communication service 234 together. The instructions may include, but are not limited to, what the communication service 234 is to do in the event the play of the audio advertisement or the converted TTS input is interrupted, instructions on how and when to play the advertisement in relation to the play of the converted TTS input—whereby the instructions may have the advertisement played before, after or during the audio play of the converted TTS input etc.

The communication package comprising the audio advertisement, the converted TTS input and the instructions, is then sent to the communication service 234 in step 518. The communication service 234, in step 520, then processes the package sent by the system processor and determines, in step 522, whether an advertisement is part of the package. If an advertisement is part of the package, the communication service 234 stores the advertisement(s) in a queue as shown in step 524. If no advertisement(s) is/are present, the communication service 234 then determines whether there are instructions or action(s) to be taken in step 526. If an action(s) is available, the action(s) are placed in a queue in step 528. If an action(s) are not available, the communication service 234 organizes the queue in step 530, thereby determining how the converted TTS input will be played, and/or when to play the advertisement(s) in relation to the audio play of the converted TTS input. The advertisement may be played before the converted TTS input, after, or at any time in relation to the audio play of the converted TTS input.

After the queue has been organized, the converted TTS input i.e. the audio of the original TTS input, is played in step 532 as dictated by the instructions. In step 534, the communication service 234 then determines if the entire converted TTS input has been played. If the entire TTS input has not been played, the process goes back to step 532 for a complete play of the converted TTS input. The advertisement may be played during the audio play of the converted TTS input. The advertisement may also be played before the play of the converted TTS input. The advertisement may also be injected and played at different junctures of the audio play of the converted TTS input. If the audio play is complete, the process proceeds to step 536, where the communication service 234 determines whether the queue is empty. If the queue is empty, the process ends. If the queue is not empty, the communication service 234 checks, in step 540, whether the item in the queue is an advertisement or not. In step 542, the item is played if the item in the queue is an advertisement . . . .

Upon playing the advertisement in step 542, the communication service 234 determines, in step 544, whether the advertisement was completely played. If the advertisement was completely played, the communication service 234 returns to step 536 from where the process proceeds to either step 538, or ends, depending on whether the queue is empty or not. If the advertisement was not completely played, the process reverts back to step 542 where the advertisement is then played to completion.

If step 540 determines that an advertisement is not included, the content presentation unit 116 determines if the item in the queue is an action item (step 546). Once the action type has been determined, the communication service 234 determines in step 548, whether the action requires confirmation from, or input, by the user for implementation. If confirmation is required, the communication service 234 formats the confirmation in step 550. If voice confirmation is required, the communication service 234 prompts the user for the user's voice input and determines if there is a positive response in step 548. If voice confirmation is not required, the communication service 234 determines whether there was a positive manual result in step 548—meaning that the user had manually confirmed to the implementation of the action. The manual result may entail pushing certain controls or buttons on the user computer 104 or 106—either on the user computer 104 or 106 or on a touch screen displayed by the communication service 234. Once confirmation is received, or if no confirmation is required, the communication service 234 executes the action in step 558.

The processing of the voice input may be implemented by using an automated speech recognition (ASR) system or a voice identification/verification system, as previously discussed. The system and process may also be enabled to play any text obtained from the ASR engine back to the user to allow the user to preview the message before the message is either sent as a message or otherwise used for any purpose. If there was a positive result by the user, then the communication service 234 performs the action in step 560. If not, i.e. where the user says “no” the communication service 234 determines whether the queue is empty in step 536, and the proceeds then proceeds from this step as previously described. The communication service 234 also proceeds to step 536 after performing the action in step 560, or if there was a negative action determination in step 558.

The system and process may be enabled to create calls to action by voice. The system and process may also be enabled to “click” by voice which may entail programmatically opening a link or beginning a download or process by using the user's voice to enable a speech to text system or ASR system to determine a positive, negative or the lack of a positive or negative response by a user. Here, such a response may trigger an action such as automatically clicking a link or advertisement. The system & process may also be enabled to allow either the system or the user to check the ASR engine's guess at what they said in an utterance. The system and process may also be enabled to allow the TTS engine to play the hypothesis of the ASR engine in order to check for mistakes.

The system and process may be enabled to initiate a call by voice whereby the phone call may be programmatically initiated by voice dialing a number on a mobile device to enable a speech to text or ASR system to determine a positive, negative, or the lack of a positive or negative response by a user, which triggers an action such as initiating or attempting to initiate a phone call, making a phone call or connecting via voice over IP or any other similar technology,

The system and process may be enabled to initiate data download by voice which may entail programmatically initiating a download or setting up a download for confirmation on a device by using the user's voice to enable a speech to text, or ASR, system to determine a positive, negative, or lack of a negative response by a user, which would then trigger an action such as the downloading of content, an application, a service, media, or any other data or information.

The system and process may be enabled to initiate payment by voice. This may entail programmatically initiating payment on a mobile device by using the user's voice to enable a speech to text or ASR system to determine a positive, negative, or lack of a negative response by the user, which would then trigger the payment action through various methods including SMS aggregation, electronic funds transfer, adding a charge directly to a phone bill, paying for credits, or through any means of compensation.

The system and process may be enabled to initiate the viewing or delivery of a coupon, reminder, ‘scheduled task or calendar entry, or other commercial or non-commercial offer delivery by voice. This may entail programmatically initiating a payment on a mobile device by using the user's voice to enable a speech to text or ASR system to determine a positive, negative or lack of a positive or negative response by the user which would then trigger the delivery of a coupon or other offer through various methods including SMS, email, instant messaging a push notification, web page, mail, delivery of a code by voice or through any other tangible or intangible system or virtual system.

The system and process may be enabled to allow a user to voice-actuate a GPS system in response to an audio advertisement being played. The user may be notified of a particular destination to which the user may direct the system to provide directions to that destination. Such actuation may be interpreted by the advertisement engine as a positive response and as a result, the GPS system may be activated thereby directing the user/consumer to the destination. Upon the user's arrival at the destination, the GPS system may notify the advertisement engine and the advertisement engine records the user as a “Delivered Customer,” to which credits may be paid to the advertisement engine by the retailer (if that was the destination). The advertisement engine may also provide the user/customer with coupons upon their arrival at the destination.

An exemplary implementation of this aspect follows: User/Customer hears an advertisement that says, “Need some coffee? There is a Starbucks just a few blocks away. Say ‘Navigate to Starbucks’ for directions.” Then consumer says “Navigate to Starbucks.” The advertisement engine marks this as a positive response and enables GPS navigation to the nearest Starbucks. Once the GPS confirms the customer is at Starbucks, the advertisement transaction may then be marked as a “Delivered Customer;” at which point a coupon or special offer may be optionally delivered to the customer. The advertisement engine may also be awarded credits for the “Delivered Customer.”

The system and process may be enabled to make or take a donation by voice, which may entail programmatically initiating a payment on a mobile device by using the user's voice to enable a speech to text or ASR system to determine a positive, negative, or lack of a positive or negative response by a user, which triggers the donation transaction, or other donation, or pledge through various methods including but not limited to SMS aggregation, electronic funds transfer, adding a charge directly to a phone bill, paying for credits, using a payment system, or through any other tangible or intangible system of payment.

The system and process may be enabled to add users to social networks, sub-pages, fan-sites, or any other websites or obtain information from same by voice. A user may be able to implement same by a “click by voice” operation, whereby the user may use his/her voice to “click” on an option for effecting an action. The system and process may be enabled to programmatically open a link, or begin a download or process, by using the user's voice to enable a speech to text system, or ASR system, to determine a positive or lack of negative response by the user. This operation may trigger an action such as clicking a link, instant messaging a push notification, sending an SMS, using an Application Programming Interface (API) call or connection or other equivalent which may automatically or manually add a user's information to a social network, sub-page(s) or sites, fan-sites, forum, social application, game or any other websites.

The system and process may be enabled to navigate through a menu of instruction or options by a user's voice. The system and process may be enabled to navigate through an audio advertisement using the user's voice. The system and process may be enabled to navigate through a song, playlist, audio file etc. using the user's voice.

The system and process may be enabled to add contacts, make calendar appointments, and set an alarm clock onto a mobile or similar device or system by voice actuation. The system and process may be enabled to have a user obtain weather, news, tasks, reminders, etc. by the user's voice actuation.

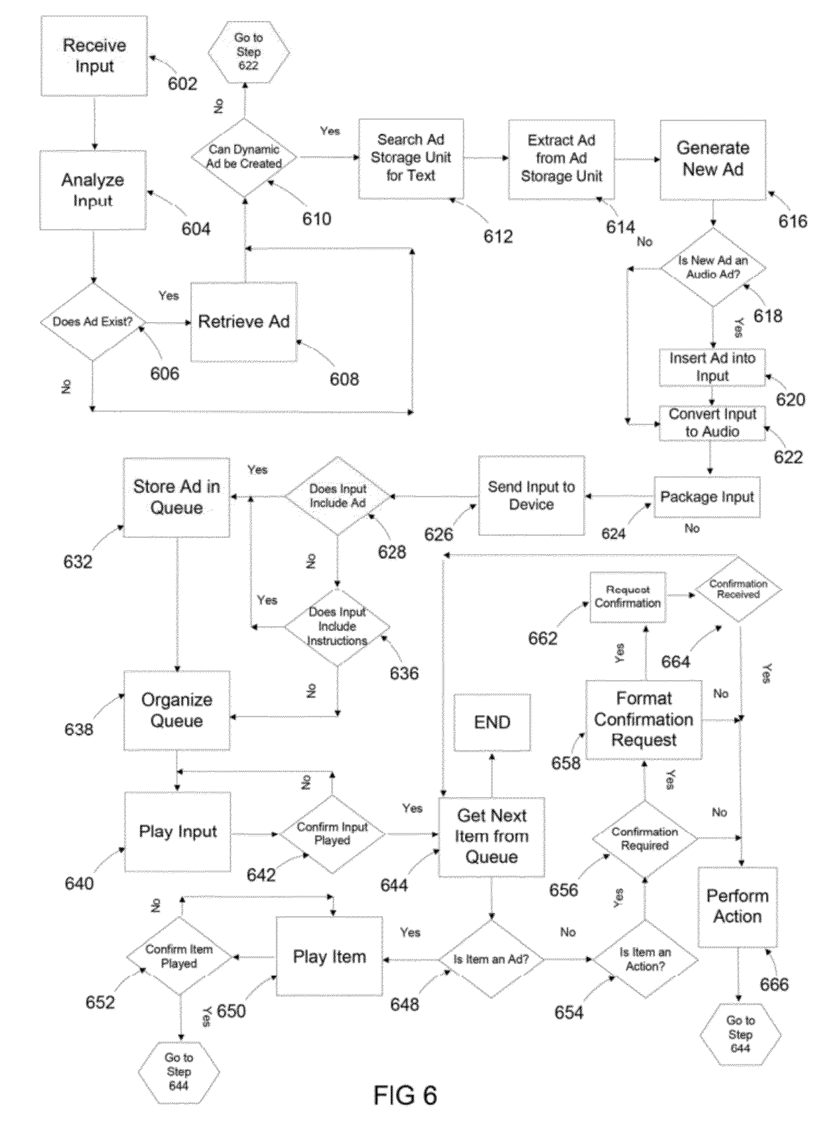

FIG. 6 is illustrative of the operation of the speech to text communication system 100. The process begins with the transmission of text to speech (TTS) input in step 602 from a communication service 234. Communications may be user generated diction, text messages, the user's utterance, a newsfeed, textual content of URLs, or any form of communication bearing textual content. The TTS input may be sent to a content presentation unit 116, which analyzes the TTS input data in step 604. In analyzing the TTS inputs data content presentation unit 116 analyzes the textual content of the TTS input and searches for key terms or words which may be correlated with an existing advertisement.

The process then proceeds to step 606 where the content presentation unit 116 determines whether an advertisement for the key word, or words, that were identified in the TTS input exist(s) in the advertisement storage unit 218. If an advertisement exists, the content presentation unit 116 retrieves the applicable advertisement in step 608. If an advertisement does not exist in the advertisement storage unit 218, the content presentation unit 116 determines, in step 610, whether a dynamic advertisement can be created. If the content presentation unit 116 determines that a dynamic advertisement is to be created, the content presentation unit 116 searches the TTS input, in step 612, for relevant text, which would be used in retrieving applicable information in the advertisement storage unit 218, in step 614. For instance, if the user obtained an SMS message from a friend in which the friend said, “I am hungry”, the system processor may select and identify the word “hungry” and then correlate the word with advertisements concerning eateries. The communication service 234 may analyze information, or data, with respect to the user, the communication service 234 being used, the user's demographic data, age, location etc. Once the information has been retrieved, the content presentation unit 116, in step 616, generates a new advertisement using both the TTS input content/text and information or data from the advertisement storage unit 218. Data such as user information, the user computer 104 or 106 being used, the user's demographic data, age, location etc. may be used in generating a targeted advertisement. The generated advertisement may be in the textual form, audio, a combination of both, etc.

The process then proceeds to step 618 where the communication service 234 determines whether the generated advertisement is an audio advertisement. If the advertisement is an audio advertisement, the content presentation unit 116, in step 620, inserts the text of the advertisement into the TTS content or communication before converting the TTS input into audio. If the advertisement is not an audio advertisement, the process moves on to step 622, where the TTS input is converted into audio.

Going back to step 610, if the content presentation unit 116 decides in step 610 that a dynamic advertisement should not be created, the process proceeds to step 622 where the original TTS input is converted to audio. Once the TTS input has been converted into audio in step 622, the content presentation unit 116, in step 624, packages the converted TTS input, the audio advertisement (if one exists as determined in step 618), and instructions for the communication service 234. The instructions may include what the communication service 234 may do in the event the play of the audio advertisement or the converted TTS input is interrupted, instructions on how and when to play the advertisement in relation to the play of the converted TTS input—whereby the instructions may have the advertisement played before, after or during the audio play of the converted TTS input etc. The communication package comprising the audio advertisement, the converted TTS input and the instructions: is then sent to the communication service 234, in step 626. The communication service 234 then processes the package sent by the content presentation unit 116, and determines, in step 630, whether an advertisement is part of the package. If an advertisement is part of the package, the communication service 234 stores the advertisement(s) in a queue as shown in step 632. If no advertisement(s) is/are present, the communication service 234 then determines whether there are instructions or action(s) to be taken in step 634. If an action(s) is available, the action(s) are placed in a queue in step 636. If no action is required, the communication service 234 organizes the queue (step 638), thereby determining how to play the converted TTS input and/or when to play the advertisement(s) in relation to the converted TTS input.

After the queue has been organized, the converted TTS input, i.e. the audio of the original TTS input, is played in step 640. The communication service 234 then checks to ensure the entire TTS input has been played in step 642. If audio play is not complete, the process returns to step 640 where the audio is played again. The process proceeds to step 644 where the next item in the queue is removed from the queue. The communication service 234 then checks, in step 648, whether the item is an advertisement or not. If it is an advertisement, it is played as shown in step 650. If it is not an advertisement, then the content presentation unit 116 determines whether it is an action and the action type in step 654.

Upon playing the advertisement in step 650, the communication service 234 determines, in step 652, whether the advertisement was completely played. If the advertisement was completely played, the communication service 234 returns to step 644 to retrieve the next item from the queue. If the advertisement was not completely played, the process reverts back to step 650 where the advertisement is then played to completion.

Referring back to step 654, once the action type has been determined, the communication service 234 determines, in step 656, whether the action requires confirmation from the user for implementation. If confirmation is required, the communication service 234 formats the confirmation in step 658. If a voice confirmation is required, the communication service 234 then prompts the user, in step 662, for the user's confirmation using an audio request and determines if there is a positive response is step 664. If a voice confirmation is not required the communication service 234 determines whether there was a positive manual result—meaning that the user had manually confirmed to the implementation of the action. The manual confirmation can entail pushing certain controls or buttons on the user computer 104 or 106—either on the user computer 104 or 106 or on a touch screen displayed by the communication service 234.

The processing of the voice input may be implemented by using an automated speech recognition (ASR) system or a voice identification/verification system. The system and process may also be enabled to play any text obtained from the ASR back to the user to allow the user to preview the message before the message is either sent as a message or otherwise used for any purpose. If there was a positive result by the user, then the communication service 234 performs the action in step 666. If there is a negative response, i.e. where the user says “no,” the communication service 234 then returns to step 644, and the process then proceeds as previously described. The communication service 234 also proceeds to step 644 after performing the action in step 666, or if there was a negative manual action determination in step 664.

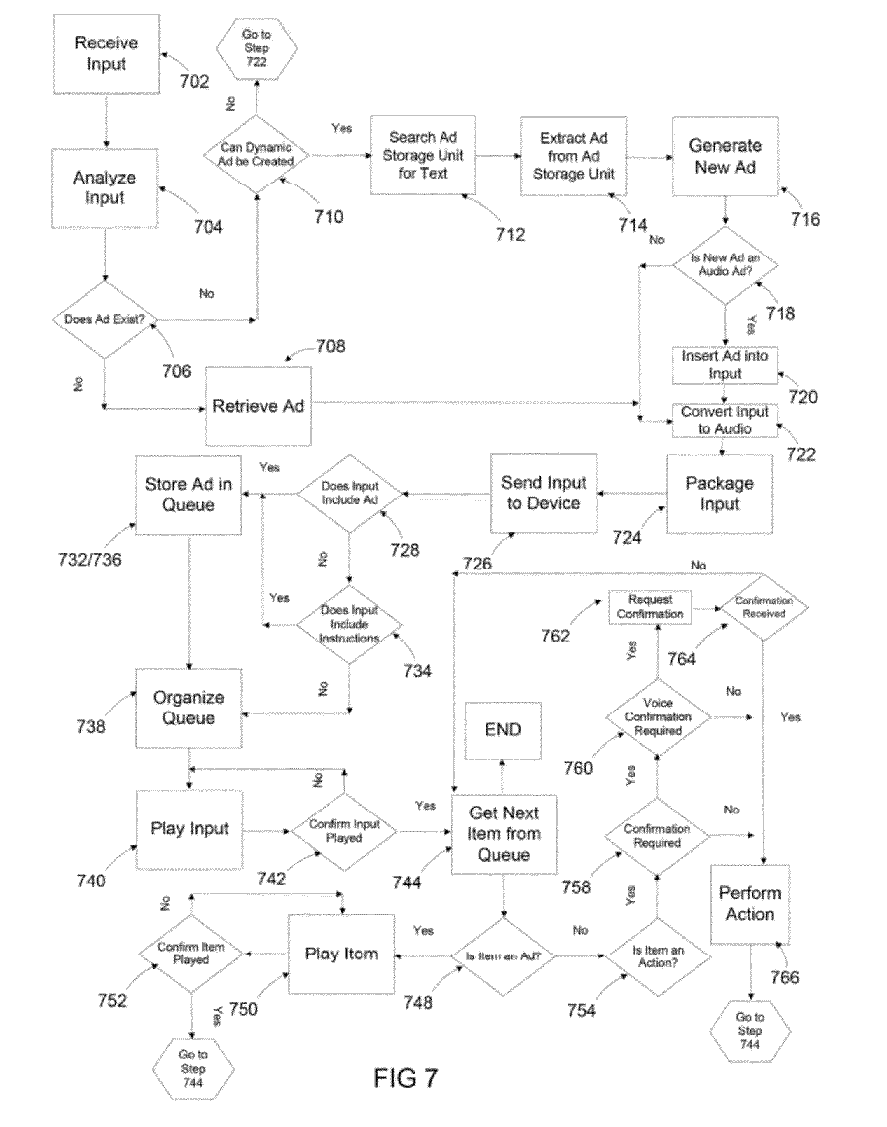

FIG. 7 is illustrative of the operation of the speech to text communication system 100. The process begins with the transmission of text to speech (TTS) input in step 702 from a communication service 234. Such communications could be user generated diction, text messages, the user's utterance, a newsfeed, textual content of URLs, or any form of communication bearing textual content. In step 704, the content presentation unit 116 analyzes the TTS input to identify keywords . . . .

The process then proceeds to step 706 where the content presentation unit 116 determines whether an advertisement for the key word, or words, identified in the TTS input exists in the advertisement storage unit 218. If a specific advertisement exists, the content presentation unit 116 retrieves the applicable advertisement in step 708. If an advertisement does not exist in the advertisement storage unit 218, the content presentation unit 218 determines, in step 710, whether a dynamic advertisement can be created. If the content presentation unit 218 determines that a dynamic advertisement can be created, the content presentation unit 218 searches the TTS input in step 712 for relevant text which would be used in retrieving applicable information in the advertisement storage unit 218. For instance, if the user obtained a TTS input such as an SMS message from a friend in which the friend said, “I am hungry”, the system processor may select and identify the word “hungry” and then correlate the word with advertisements concerning eateries. The content presentation unit 218 may analyze information or data with respect to the user, the communication service 234 being used, the user's demographic data, age, location etc. Once the information has been retrieved, the system processor then in step 716 generates a new advertisement using both the TTS input content/text and information or data from the advertisement storage unit 218. Additional data such as information or data with respect to the user, the communication service 234 being used; the user's demographic data, age, location etc. may be used to generate a targeted advertisement.

In step 714, the content presentation unit 218 extracts the advertisement information relating to the identified keyword from the advertisement storage unit 218. In step 716, the content presentation unit 218 generates an advertisement using the extracted information using any of the previously discussed methods. The generated advertisement may be in text, audio, or a combination of formats that may be displayed or played for the user.

The process then proceeds to step 718 where the content presentation unit 218 determines whether the generated advertisement is an audio advertisement. If the advertisement is an audio advertisement, the system processor in step 720 inserts the text of the generated advertisement into the TTS content, or communication, before converting the TTS input into audio. If the advertisement is not an audio advertisement, the process moves on to step 722, where the TTS input is converted into audio. Going back to step 710, if the system processor decides in step 710 that a dynamic advertisement is not to be created, the process proceeds to step 722 where the original TTS input is converted to audio.

Once the TTS input has been converted into audio, in step 722, the content presentation unit 218, in step 724, packages the converted TTS input, the audio advertisement (if one exists as determined in step 718) and instructions for the communication service 234 together. The instructions may include what the communication service 234 is to do in the event the play of the audio advertisement or the converted TTS input is interrupted, instructions on how and when to play the advertisement in relation to the play of the converted TTS input—whereby the instructions may have the advertisement played before, after or during the audio play of the converted TTS input etc. The communication package comprising of the audio advertisement, the converted TTS input and the instructions, is then sent to the communication service 234, in step 726.

The communication service 234 processes the package sent by the content presentation unit 116 to determine, in step 728, whether an advertisement is part of the package. If an advertisement is part of the package, the communication service 234 stores the advertisement(s) in a queue as shown in step 732. If no advertisement(s) is/are present, the communication service 234 then determines whether there are instructions or action(s) to be taken in step 734. If an action(s) is available, the action(s) are placed in a queue in step 736. If an action is not available, the communication service 234 organizes the queue (step 738) thereby determining how to play the converted TTS input and/or when to play the advertisement(s) in relation to the converted TTS input.

After the queue has been organized, the converted TTS input i.e. the audio of the original TTS input is played in step 740. The communication service 234 then checks to see if the entire TTS input has been played, in step 742. If the entire TTS input has not been played, the process goes back to step 740 for a complete play of the converted TTS input. If the audio play is complete, the process proceeds to step 744 where the communication service 234 retrieves the next item from the queue. If the queue is empty, meaning no items are in the queue, the process ends.

If the queue is not empty, another item is then removed from the queue. The communication service 234 determines, in step 748, whether the item is an advertisement. If the item is an advertisement, the item is played in step 750. If the item is not an advertisement, then the communication service 234 determines whether the item is an action in step 754. Upon playing the advertisement in step 750, the communication service 234 determines, in step 752, whether the advertisement was completely played. If the advertisement was not completely played, the communication service 234 Going back to step 752, if the TTS audio play was not interrupted, then the process proceeds to step 754 where the communication service 234 determines whether the advertisement was fully played. If the communication service 234 determines that the advertisement was fully played, then the process proceeds to step 348. If the advertisement was not completely played, the process reverts back to step 750 where the advertisement is then played to completion. If the advertisement has been completely played, the process returns to step 744.

Referring back to step 754, once the action type has been determined, the communication service 234 determines in step 758, whether the action requires confirmation from the user for implementation. If confirmation is required, the communication service 234 formats the confirmation in step 760. If a voice confirmation is required, the communication service 234 then prompts the user, in step 762, for the user's voice input. If not, the communication service 234 in step 764 determines whether there was a positive result or a manual result—meaning that the user had manually confirmed to the implementation of the action. The manual result can entail pushing certain controls or buttons on the user computer 104 or 106—either on the user computer 104 or 106 or on a touch screen displayed by the communication service 234. If either there was a positive result in step 764, or if no confirmation was required, the process proceeds to perform the action in step 766. In addition, following the user's voice input in step 762, the communication service 234 processes the user's voice in and then determines from the processed voice input whether there was a positive result, i.e. a confirmation for the communication service 234 to proceed with the action.

The processing of the voice input may be implemented using an automated speech recognition (ASR) system or a voice identification/verification system. The system and process may also be enabled to play any text obtained from the ASR engine back to the user to allow the user to preview the message before the message is either sent as a message or otherwise used for any purpose. If there was a positive result by the user, then the communication service 234 performs the action in step 766. If not, i.e. where the user says “no,” the process returns to step 744 continues as previously described. The communication service 234 also proceeds to step 744 after performing the action in step 766 or if there was a negative manual action determination in step 760.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A device including a processor and a memory, the processor operating software performing a method of providing content to a device, the method including the steps of:
receiving an input from a sending device;
gathering information pertaining to the sending device or a receiving device;
searching a storage unit for content related to the information and the input;
generating a message based on the content returned from the storage unit;
incorporating the message into the input;
transmitting the input including the message to the receiving device.

2. The device of claim 1 including the steps of
receiving a response to the input from the receiving device; and
generating a second message based on the received response.

3. The device of claim 2 including the step of initiating an action based on the response to the input.

4. The device of claim 1 wherein the step of generating the message includes the steps of
gathering content portions from the storage unit;
creating a sentence or a phrase using the content portions and a plurality of bridge words from a language unit.

5. The device of claim 1, wherein the step of presenting in the input includes the step of converting the message into an audio format.

6. The device of claim 5 wherein the step of presenting in the input includes the step associating the audio with a video image.

7. The device of claim 1 wherein the step of incorporating the message into the input includes the steps of
converting the input into a text format;
converting the message into the text format;
inserting the message into the text of the input.

8. The device of claim 1 wherein the information pertaining to the sending device or receiving device includes location information of the sending device or receiving device.

9. The device of claim 1 wherein the step of searching the storage unit for content related to the information and the input includes the steps of
analyzing the input to determine at least one topic in the input;
searching a client storage unit for client information based on the at least on topic;
searching an advertisement storage unit for an advertisement based on the client information.

10. The device of claim 2 wherein the step of generating a second message based on the received response includes the steps of
searching the client storage unit for a second client information using another topic identified in the input;
searching an advertisement storage unit for a second advertisement based on the second client information;
generating a message using the advertisement and information about the sending or receiving device; and
transmitting the message to the receiving device.

11. The device of claim 1 wherein the receiving device presents the input to a user via a speaker coupled to the receiving device.

12. An advertisement system having a content creation device including:
an input receiving unit that receives an input from a sending device;
an information gathering unit that gathers information pertaining to the sending device or a receiving device;
a content storage unit;
a message generation unit that searches the content storage unit for content based on the sending or receiving device and the input;
a content presentation unit that transmits the input including the message to the receiving device,
wherein the message generation unit incorporates the message into the input.

13. The system of claim 11 wherein
the content presentation unit receives a response to the input from the receiving device and generates a second message based on the received response.

14. The system of claim 11, wherein the content is an action the receiving device performs.

15. The system of claim 11 wherein the message generation unit gathers content portions from the content storage unit and creates a sentence using the content portions and a plurality of bridge words from a language unit.

16. The system of claim 11, wherein the receiving unit includes a speaker which presents the input to a user of the receiving device.

17. The system of claim 11 wherein the message generating unit converts the input into a text format and inserts the message into the converted text.

18. The system of claim 11 wherein the information pertaining to the sending device includes location information of the sending device.

19. The system of claim 11 wherein the message generation unit analyzes the input to determine at least one topic in the input, searches a client storage unit for client information based on the at least one topic, and searches an advertisement storage unit for an advertisement based on the client information.

20. The system of claim 12 wherein the content generation unit searches the client storage unit for a second client information using another topic identified in the input, searches an advertisement storage unit for a second advertisement based on the second client information, generates a message using the advertisement and information about the sending and receiving device, and transmits the message to the receiving device.
